(19) United States
(12) Patent Application Publication
(10) Pub. No.: US 2021/0117236 A1
(43) Pub. Date: Apr. 22, 2021

(54) SYSTEM FOR MACHINE INTELLIGENCE RESOURCE AGENT INDICATOR OUTPUT

(71) Applicant: BANK OF AMERICA CORPORATION, Charlotte, NC (US)

(72) Inventors: Sonesh Prafulkumar Patel, London (GB); Anita Maheshbhai Patel, London (GB)

(73) Assignee: BANK OF AMERICA CORPORATION, Charlotte, NC (US)

(21) Appl. No.: 16/775,457

(22) Filed: Jan. 29, 2020

Related U.S. Application Data
(60) Provisional application No. 62/923,560, filed on Oct. 20, 2019.

(51) Int. Cl. G06F 9/50; G06N 7/00; G06N 20/00

(52) U.S. Cl. CPC G06F 9/5027; G06N 20/00; G06N 7/005

(57) ABSTRACT

Embodiments of the invention are directed to a system, method, or computer program product for an application hub for generation and deployment of a suite of models for equity resource exchange and initial equity resource offering predictors. In some embodiments, the invention may provide an indication on which of the one or more resource agents may be interested in interaction with in an entity performing an initial equity resource offering across an equity resource exchange. The invention provides a predictive analytics approach for identification and prediction of resource agents by processing real-time selected data segments for machine learning network structure that contains nodes or layers that are stacked to perform a specific task and review of a data segment and provide prediction outputs for resource agent predicted interaction involvement.

### CROSS-REFERENCE TO RELATED APPLICATION

This application is a non-provisional application of and claims priority to co-pending U.S. Provisional Patent Application No. 62/923,560 filed Oct. 20, 2019 and titled “SYSTEM FOR MACHINE INTELLIGENCE RESOURCE AGENT INDICATOR OUTPUT”, the entire disclosure of which is hereby incorporated herein by reference.

### BACKGROUND

Interaction for workflows in advance of initial equity resource offerings is a complex process requiring workflow knowledge, market knowledge, entity knowledge, and the like for identification of resource agents for the same. As such, there exists a need for an inline predictive intelligence analytics machine for workflow and offering syndication preparation and deployment.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Currently, the process from initial entity determination of performing an initial equity resource offering to the launch of the offering is a several year process.

In some embodiments, the invention provides an inline predictive intelligence analytics machine for workflow and offering across an equity resource exchange. The system for machine intelligence indicator output includes an artificial intelligence engine for interaction prediction. The system utilized a network for machine learning algorithms to understand workflows and provide real-time predictions to assist in syndication.

The system inputs structured data scrubbed from raw unstructured training data, performs modeling via processing through supervised machine learning algorithms to identify resource agent patterning, and provides a secure graphical user interface for scoring and ranking of resource agents for specific interactions.

The system provides an application hub for generation and deployment of a suite of models for equity resource exchange and initial equity resource offering predictors. In some embodiments, the system may provide an indication on which of the one or more resource agents may be interested in an entity performing an initial equity resource offering across an equity resource exchange. The system provides a data driven predictive analytics approach for identification and prediction of resource agents. As such, the system learns resource agent strategies to predict one or more resource agents for purchase of equity of an entity requesting an initial equity resource offering. Embodiments of the present invention address these and/or other needs by providing an innovative system, method and computer program product for machine intelligent resource agent indicator output, the invention comprising: identifying an interaction, wherein the interaction is an equity resource exchange or an initial equity resource offering requiring resource agents; compiling data from data segments associated with the interaction, wherein the data segments include historical interaction data segments, issuer data segments, research data segments, and sales data segments; identifying target resource agents for injection into the interaction based on process the compiled data from the data segments via machine learning modeling; calculating a probability match and a probability order size for each of the target resource agents identified for injection into the interaction; and generating and display for a results report on a secure user access via an application hub, wherein the results report includes a graphical user interface with target resource agents and calculated probability matches.

In some embodiments, the invention further comprises feeding results of equity resource exchange or an initial equity resource offering and target resource agent involvement back into the machine learning modeling for enhanced accuracy via backpropagation.

In some embodiments, the results report further comprises a pitch strategy for approaching the target resource agents for equity resource exchange or an initial equity resource offering funding based on agent historical interaction data.

In some embodiments, the data from data segments is compiled into a single display for a user and is walled from data sources and outputs prohibiting cross contact of data across an sector.

In some embodiments, data from data segments comprise historical interaction data, wherein historical interaction data includes data from previous resource agent interactions, previous involvement in entity initial equity resource offerings, wherein the historical interaction data is further parsed into an interaction type, an issuer location, and an interaction sector.

In some embodiments, the data from data segments comprise issuer data, wherein issuer data further comprises entity trends, entity volatility, and an identification of what resource agents are currently invested with the entity prior to the initial equity resource offering.

In some embodiments, the data from data segments comprise research data, wherein the research data further comprises research of an entity or sector within a line of business.

In some embodiments, the data from data segments comprise sales data, wherein the sales data further comprises identifying when the user contacts a resource agent and identifying the resource agent contacts overtime with respect to sectors or entities include interaction volumes, a touchpoint count, and sector sales.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1A provides an intelligent indicator output system environment, in accordance with one embodiment of the present invention;

FIG. 1B provides a high level process flow illustrating implementation of AI into resource agent identification, in accordance with one embodiment of the present invention;

FIG. 2 provides a high level process flow illustrating data element capture and deployment for resource agent identification, in accordance with one embodiment of the present invention;

FIG. 3 provides a process flow for implementation and deployment of machine intelligence resource agent indicator output, in accordance with one embodiment of the present invention;

FIG. 4 provides an interface illustrating an input tab of the interaction calculator application associated with the machine intelligence resource agent indicator output system, in accordance with one embodiment of the present invention;

FIG. 5 provides an interface illustrating an execution tab of the interaction calculator application associated with the machine intelligence resource agent indicator output system, in accordance with one embodiment of the present invention;

FIG. 6 provides an interface illustrating a model tab of the interaction calculator application associated with the machine intelligence resource agent indicator output system, in accordance with one embodiment of the present invention; and

FIG. 7 provides an interface illustrating a results tab of the interaction calculator application associated with the machine intelligence resource agent indicator output system, in accordance with one embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

A “user” as used herein may refer to any individual involved in entity determination of performing an initial equity resource offering to the launch of the offering on the equity resource exchange. The user may interact with an entity or systems of the invention. Furthermore, as used herein the term “user device” or “mobile device” may refer to mobile phones, personal computing devices, tablet computers, wearable devices, and/or any portable electronic device capable of receiving and/or storing data therein.

As used herein, a “user interface” generally includes a plurality of interface devices and/or software that allow a customer to input commands and data to direct the processing device to execute instructions. For example, the user interface may include a graphical user interface (GUI) or an interface to input computer-executable instructions that direct the processing device to carry out specific functions. Input and output devices may include a display, mouse, keyboard, button, touchpad, touch screen, microphone, speaker, LED, light, joystick, switch, buzzer, bell, and/or other user input/output device for communicating with one or more users.

A “technology activity” or “activity” may include a data input onto the system to produce or perform predictive analytics to determine an appropriate resource agent. A “resource agent” may be one or more individuals, entities, financial institutions, or the like that may invest in an entity at a stage of initial equity resource offering of the entity. This may be an investor or the like. The term “interaction” may refer to any activity with respect to resource distribution occurring in the past for resource agents for prior initial equity resource offerings on an equity resource exchange, resource agent general activities on an equity resource exchange, and/or the like.

The term “equity resource exchange” may include a capital market or other financial market which long-term or equity backed securities are bought and sold. The equity resource exchange may comprise either a primary or secondary market. The term “initial equity resource offering” may include an initial public offering were portions of an entity may be bought or sold across an open exchange. Thus the initial transfer of private to public. Furthermore, the term initial equity resource offering may include other equity capital market products such as selling of primary shares, selling of secondary shares, a block deal, an accelerated bookbuild, follow on deal, or the like. Furthermore the term may include convertible bond deals and the like.

In some embodiments, the invention provides an inline predictive intelligence analytics machine for workflow and offering across an equity resource exchange. The system for machine intelligence indicator output includes an artificial intelligence engine for interaction prediction. The system utilized a network for machine learning algorithms to understand workflows and provide real-time predictions.

The system inputs structured data scrubbed from raw unstructured training data, performs modeling via processing through supervised machine learning algorithms to identify resource agent patterning, and provides a secure graphical user interface for scoring and ranking of resource agents for specific interactions.

The system provides an application hub for generation and deployment of a suite of models for equity resource exchange and initial equity resource offering predictors. In some embodiments, the system may provide an indication on which of the one or more resource agents may be interested in an entity performing an initial equity resource offering across an equity resource exchange. The system provides a data driven predictive analytics approach for identification and prediction of resource agents. As such, the system learns resource agent strategies to predict one or more resource agents for purchase of equity of an entity requesting an initial equity resource offering.

Currently users or equity capital market users must optimize demands for interactions by balancing supply and resource agent demand. The system provides an AI based system that develops insights in to resource agent interest and potential participation within each interaction. By using a network of machine learning algorithms and appropriate real-time data input, the system provides a predicted understanding of relationship trends between interactions and resource agents.

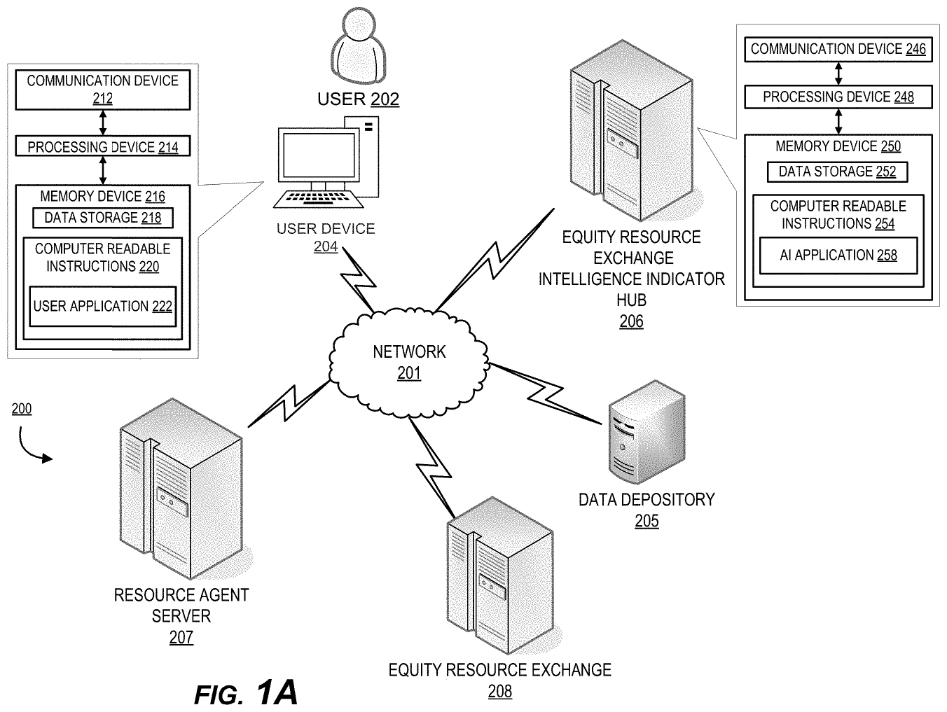

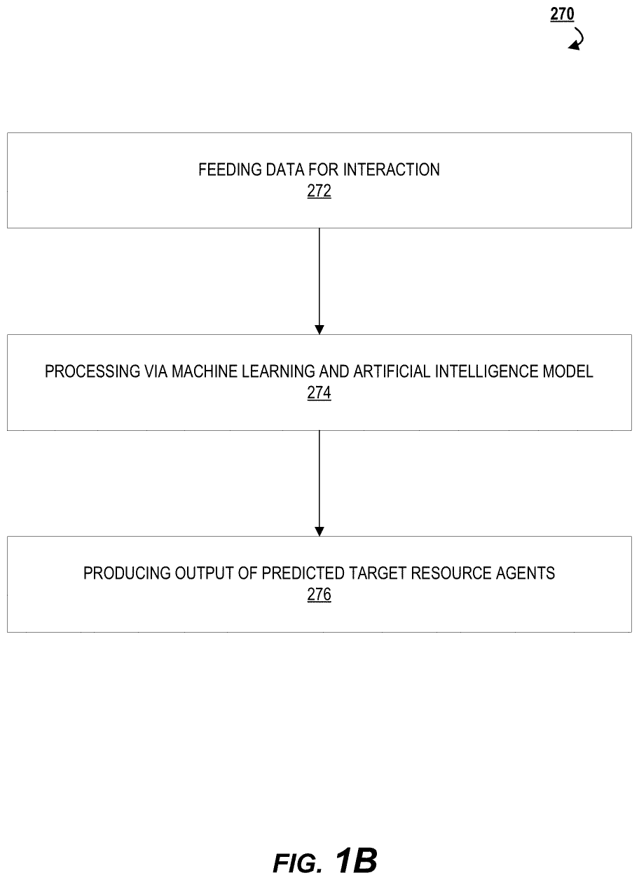

FIG. 1A provides an intelligent indicator output system environment 200, in accordance with one embodiment of the present invention. FIG. 1A provides the system environment 200 for which the distributive network system with specialized data feeds associated with an interconnected resource distribution and retention network. FIG. 1A provides a unique system that includes specialized servers and system communicably linked across a distributive network of nodes required to perform the functions described herein. In some embodiments, the invention provides an application hub for generation and deployment of a suite of models for equity resource exchange and initial equity resource offering predictors. In some embodiments, the system may provide an indication on which of the one or more resource agents may be interested in an entity performing an initial equity resource offering across an equity resource exchange. The system provides a data driven predictive analytics approach for identification and prediction of resource agents. As such, the system learns resource agent strategies to predict one or more resource agents for purchase of equity of an entity requesting an initial equity resource offering.

As illustrated in FIG. 1, the equity resource exchange 208 is operatively coupled, via a network 201 to the user device 204, data depository 205, resource agent servers 207, and to the equity resource exchange intelligence indicator hub 206. In this way, the equity resource exchange 208 can send information to and receive information from the user device 204, data depository 205, resource agent servers 207, and the equity resource exchange intelligence indicator hub 206. FIG. 1A illustrates only one example of an embodiment of the system environment 200, and it will be appreciated that in other embodiments one or more of the systems, devices, or servers may be combined into a single system, device, or server, or be made up of multiple systems, devices, or servers.

The network 201 may be a system specific distributive network receiving and distributing specific network feeds and identifying specific network associated triggers. The network 201 may also be a global area network (GAN), such as the Internet, a wide area network (WAN), a local area network (LAN), or any other type of network or combination of networks. The network 201 may provide for wireline, wireless, or a combination wireline and wireless communication between devices on the network 201.

In some embodiments, the user 202 is an individual or entity that has one or more user devices 204 and is an agent associated with the system involved in entity determination of performing an initial equity resource offering to the launch of the offering on the equity resource exchange. In some embodiments, the user 202 has a user device, such as a mobile phone, tablet, computer, or the like. FIG. 1A also illustrates a user device 204. The user device 204 may be, for example, a desktop personal computer, business computer, business system, business server, business network, a mobile system, such as a cellular phone, smart phone, personal data assistant (PDA), laptop, or the like. The user device 204 generally comprises a communication device 212, a processing device 214, and a memory device 216. The processing device 214 is operatively coupled to the communication device 212 and the memory device 216. The processing device 214 uses the communication device 212 to communicate with the network 201 and other devices on the network 201, such as, but not limited to the equity resource exchange intelligence indicator hub 206, the equity resource exchange 208, and the third party sever 207. As such, the communication device 212 generally comprises a modem, server, or other device for communicating with other devices on the network 201.

The user device 204 comprises computer-readable instructions 220 and data storage 218 stored in the memory device 216, which in one embodiment includes the computer-readable instructions 220 of a user application 222. In some embodiments, the user application 222 allows a user 202 to send and receive communications with the equity resource exchange intelligence indicator hub 206 in order to process receive predictions from the equity resource exchange intelligence indicator hub 206 for resource agent identification.

As further illustrated in FIG. 1, the equity resource exchange intelligence indicator hub 206 generally comprises a communication device 246, a processing device 248, and a memory device 250. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 248 is operatively coupled to the communication device 246 and the memory device 250. The processing device 248 uses the communication device 246 to communicate with the network 201 and other devices on the network 201, such as, but not limited to the equity resource exchange 208, the resource agent server 207, the data depository 205, and the user device 204. As such, the communication device 246 generally comprises a modem, server, or other device for communicating with other devices on the network 201.

As further illustrated in FIG. 1, the equity resource exchange intelligence indicator hub 206 comprises computer-readable instructions 254 stored in the memory device 250, which in one embodiment includes the computer-readable instructions 254 of an AI application 258. In some embodiments, the memory device 250 includes data storage 252 for storing data related to the system environment 200, but not limited to data created and/or used by the application 258.

In one embodiment of the equity resource exchange intelligence indicator hub 206 the memory device 250 stores an AI application 258. In one embodiment of the invention, the AI application 258 may associate with applications having computer-executable program code. Furthermore, the equity resource exchange intelligence indicator hub 206, using the processing device 248 codes certain communication functions described herein. In one embodiment, the computer-executable program code of an application associated with the AI application 258 may also instruct the processing device 248 to perform certain logic, data processing, and data storing functions of the application. The processing device 248 is configured to use the communication device 246 to communicate with and ascertain data from one or more equity resource exchange 208, resource agent servers 207, data depository 205, and/or user device 204. The equity resource exchange intelligence indicator hub 206 may generally include a processing device communicably coupled to devices as a memory device, output devices, input devices, a network interface, a power source, one or more chips, and the like. The equity resource exchange intelligence indicator hub 206 may also include a memory device operatively coupled to the processing device. As used herein, memory may include any computer readable medium configured to store data, code, or other information. The memory device may include volatile memory, such as volatile Random Access Memory (RAM) including a cache area for the temporary storage of data. The memory device may also include non-volatile memory, which can be embedded and/or may be removable. The non-volatile memory may additionally or alternatively include an electrically erasable programmable read-only memory (EEPROM), flash memory or the like.

The memory device may store any of a number of applications or programs which comprise computer-executable instructions/code executed by the processing device to implement the functions of the equity resource exchange intelligence indicator hub 206 described herein.

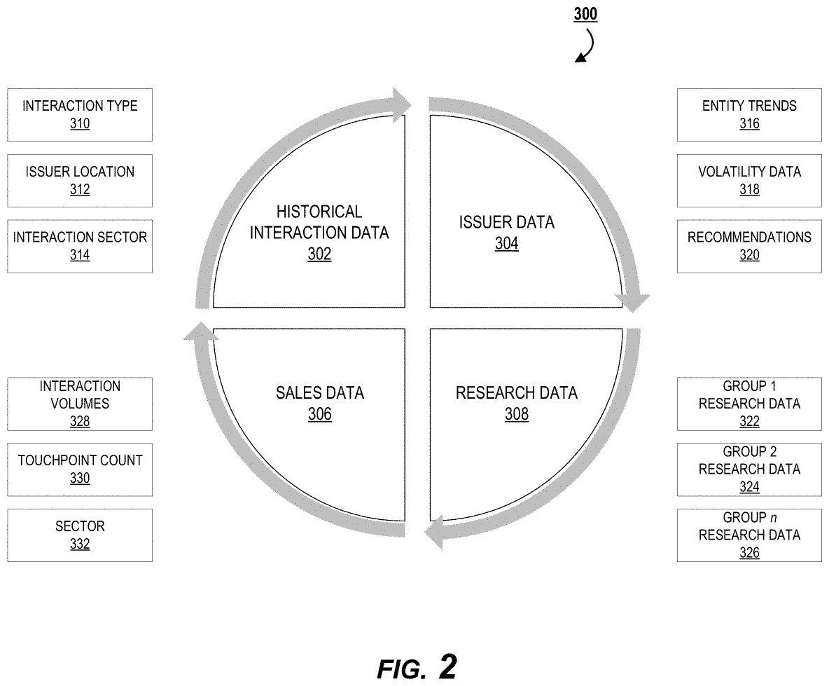

In the illustrated embodiment, the equity resource exchange intelligence indicator hub 206 further comprises an artificial intelligence (AI) applications and a neural network learning application which may be separate systems operating together with the equity resource exchange intelligence indicator hub 206 or integrated within the equity resource exchange intelligence indicator hub 206. The machine learning system implemented within the equity resource exchange intelligence indicator hub 206 is a network structure that contains nodes or layers that are stacked to perform a specific task and review of a data segment further illustrated below in FIG. 2. Each type of layer represents a specific low-level transformation (e.g., convolution, pooling) of the input data with specific parameters (i.e., weights). The architecture is an abstraction of a set of networks or applications that have the same types and order of layers but do not specify the number and dimension of layers. A set of hyper-parameters specifies how one consolidates an architecture to a network (e.g., it defines the convolution layer dimensions or the number of convolutions in the layer group). The hyper-parameters also determine which optimizer is used in training along with the optimization parameters, such as the learning rate and momentum. The system can then model (or trained model), a network that has been trained, which has fixed weights to present machine intelligence resource agent indication output for entities involved in an initial equity resource offering.

The equity resource exchange intelligence indicator hub 206 furthermore provides for establishing intelligent, proactive and responsive communication with a user, comprising a multi-channel cognitive resource platform for displaying predictive results and activities in an integrated manner from a single interface. The equity resource exchange intelligence indicator hub 206 is also configured for adapting to the user's natural communication and its various modes by allowing seamless switching between communication channels/mediums in real time or near real time.

Based on analyzing the received activity input, the equity resource exchange intelligence indicator hub 206 is configured to determine and predict via the data depository 205 and AI processing a resource agent prediction for based on the user activity the user seeks to perform. Here, in general, the equity resource exchange intelligence indicator hub 206 may parse the input from the user to detect prospective resource agents. The equity resource exchange intelligence indicator hub 206 may perform analysis determine possible matches of resource agents to entities associated with a potential initial equity resource offering based on the user activity.

Specifically, based on receiving the activity input from the user, in some instances, the equity resource exchange intelligence indicator hub 206 is configured to generate a graphical user interface display of a prediction based on multiple data inputs and extractions.

The equity resource exchange intelligence indicator hub 206 is configured for initiate presentation of predicted resource agents via an interface associated with a multi-channel response application stored on the user device. The equity resource exchange intelligence indicator hub 206 may receive user input. The equity resource exchange intelligence indicator hub 206 may be configured to interpret and transform, seamlessly and in real-time, one medium to another for presentation on the central user interface a prediction based on those inputs. The equity resource exchange intelligence indicator hub 206 may present the received activity input from the user in a textual format. The equity resource exchange intelligence indicator hub 206 may similarly respond to the user input, as indicated by the output. In addition, the equity resource exchange intelligence indicator hub 206 may present one or more interactive elements for facilitating the prediction and advanced activities, which are embedded, integrated into, or overlaid over the central user interface.

In addition, the equity resource exchange intelligence indicator hub 206 is intuitive and is configured to hold complex and branched processing based on user input in the pursuit of completing one or more activities. Furthermore, the equity resource exchange intelligence indicator hub 206 is configured to present to an integrated central user interface for communicating with the user for providing execution of one or more user activities such as resource agent prediction for entity initial equity resource offering.

As illustrated in FIG. 1, the resource agent server 207 is connected to the equity resource exchange 208, user device 204, data depository 205, and equity resource exchange intelligence indicator hub 206. The resource agent server 207 has the same or similar components as described above with respect to the user device 204. While only one resource agent server 207 is illustrated in FIG. 1, it is understood that multiple resource agent servers 207 may make up the system environment 200. The resource agent server 207 may be associated with one or more resource agents, entities, or the like.

As illustrated in FIG. 1, the data depository 205 is connected to the equity resource exchange 208, user device 204, resource agent server 207, and equity resource exchange intelligence indicator hub 206. The data depository 205 has the same or similar components as described above. While only one data depository 205 is illustrated in FIG. 1, it is understood that multiple data depository 205 may make up the system environment 200.

The data depository 205 stores data for deployment on the equity resource exchange intelligence indicator hub 206. In this way, the data depository 205 may store step by step instructions for AI processing and prediction of resource agents for the initial equity resource offering.

The data depository 205 may be connected to the equity resource exchange intelligence indicator hub 206 via the network 201 for the equity resource exchange intelligence indicator hub 206 to perform a processing function. Furthermore, the data depository 205 may communicate with the same network protocol and compatibility with the equity resource exchange 208 for deployment of the data to the equity resource exchange intelligence indicator hub 206.

As illustrated in FIG. 1, the equity resource exchange 208 is connected to the resource agent server 207, user device 204, data depository 205, and equity resource exchange intelligence indicator hub 206. The equity resource exchange 208 may be associated with the equity resource exchange platform for the trading of equity resources. It is understood that the servers, systems, and devices described herein illustrate one embodiment of the invention. It is further understood that one or more of the servers, systems, and devices can be combined in other embodiments and still function in the same or similar way as the embodiments described herein.

Currently, the process from initial entity determination of performing an initial equity resource offering to the launch of the offering is a several year process. A syndicate selection process is performed, an offering process in prepared, analysis and research is conducted, resource agents are presented with data, book building is executed, and pricing allocation and settlement are performed. These processes are time consuming involving asset managers, insurance, funds, and entities, all in communication and syndication for processing. The invention, on the other hand, presents an expeditated resource agent determination process.

FIG. 1B provides a high level process flow illustrating implementation of AI into resource agent identification 270, in accordance with one embodiment of the present invention.

As illustrated in block 272, the process 270 is initiated by collecting and feeding data for the interaction from the data depository. In this way, the system identifies all of the key data elements and feeds those elements into the model. These data elements illustrate and provide indications as to why a resource agent may be a likely candidate for this initial equity resource offering. There are data points from the resource agents, interaction history, interaction size, exchange, valuation metrics, issuer, allocations, holdings, entity sized, participations, broker recommendations, and the like. The data feeding is further illustrated below in FIG. 2.

Next, as illustrated in block 274, the process 270 continues by preforming processing via artificial intelligence modeling. In this way, the data is feed into a live prediction element for new interactions for future initial equity resource offerings. In this way, the system may input information about the entity associated with the initial equity resource offering and via performing machine learning via multi-core processors generate a prediction of resource agents most likely to invest resources into the entity associated with the initial equity resource offering.

Finally, as illustrated in block 276, the process 270 is finalized by producing an output of predicted targeted resource agents. In this way, the AI and machine learning processing may provide a list of target resource agents including probabilities for placing an order with the initial equity resource offering.

FIG. 2 provides a high level process flow illustrating data element capture and deployment for resource agent identification 300, in accordance with one embodiment of the present invention. There are four segments each containing multiple data points. The data points within each of the four segments evolve in real-time based on historic accuracies, market modifications, and the like. The four segments include historical interaction data 302, issuer date 304, research data 308, and sales data 306. Currently, standard data sources include the historical interaction data 302 and issuer data 304, however the system allows for the processing of additional data segments to provide resource agent predictions.

In some embodiments historical interaction data 302 comprises data and information from previous interactions. These previous interactions may be previous resource agent interactions, previous involvement in entity initial equity resource offerings, or the like. The data segment is parsed into the interaction type 310, the issuer location 312, and the interaction sector 314. The interaction type 310 includes the type of interaction, whether it be an initial equity resource offering, purchasing/selling of stocks, or the like. The issuer location 312 provides an indication of the location of the entity of the interaction. The interaction sector 314 provides an indication to the sector the entity is in, such as technology, consumer goods, healthcare, or the like. In this way, the system may identify that the entity looking for resource agents is performing an interaction type of an initial equity resource offering, is based on country A, and is in the technology sector.

Using this information, the system may identify all historic interactions the system has data for and identify the resource agents that have participated in similar interactions in the past. As such, the system may be able to identify the resource agents that have been involved in similar types of interactions in the past with similar entities performing initial equity resource offerings based on the interaction type 310, issuer location 312, and interaction sector 314.

In some embodiments the data segments further comprise issuer date 304. This data is focused on the entity level data that is used to identify how attractive the entity involved in the initial equity resource offering may be to resource agents. The data segment reviews entity trends 316, volatility data 318, and recommendations 320 all focused on the individual entity associated with the initial equity resource offering. The system may also review what other resource agents are already investing with the entity prior to the initial equity resource offering.

In some embodiments the data segments further comprise research data 308. Research data 308 generates research associated with various line of business data points. As such, when a research report about an entity, sector, or the like, is generated the system may identify the report and visualization of the report from entities and/or resource agents. In this way, the system may identify group 1 research data 322, group 2 research data 324, to group n research data 326.

In some embodiments the data segments further comprise sales data 306. Sales data 306 sector includes sales and trading data. The system may be able to identify when a user contacts a resource agent and identifies the resource agent contacts overtime with respect to sectors, entities, or the like. This may include interaction volumes 328, a touchpoint count 330, or sector sales 332.

The data may be compiled into a single display for users. Thus making the user walled off or separated from the specific data sources and the outputs from those sources. In this way prohibiting cross contact of data across an entity or sector. Furthermore, the data sectors illustrated in FIG. 2 are continuously updated and modified in real-time based on environmental changes, performance reviews of data, trends, and the like.

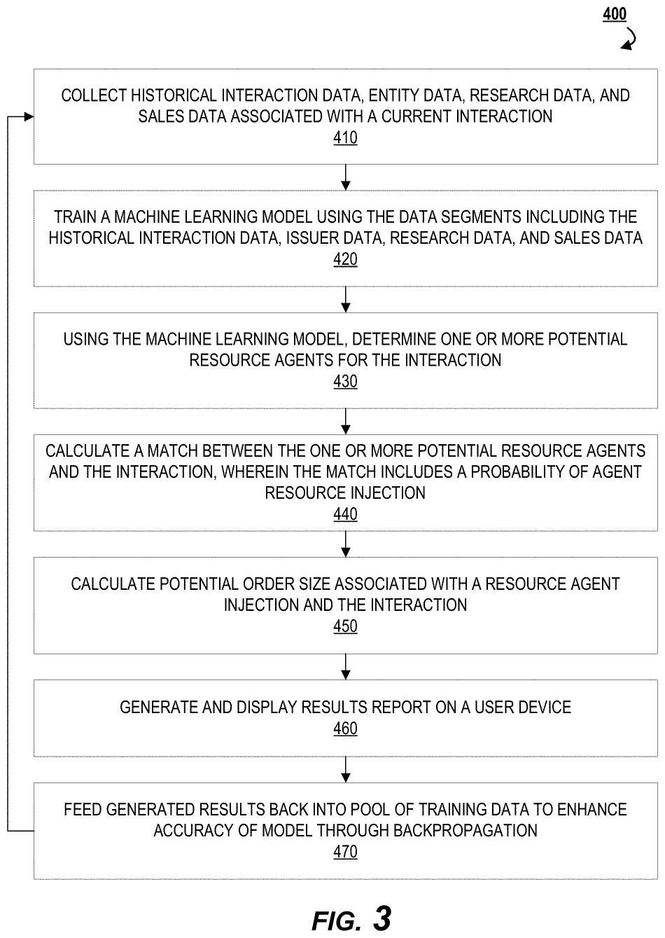

FIG. 3 provides a process flow for implementation and deployment of machine intelligence resource agent indicator output 400, in accordance with one embodiment of the present invention. As illustrated in block 410, the process 400 is initiated by collecting the data for the data segments and store the data within the data depository. This may include collecting historical interaction data, entity data, research data, and sales data segments associated with the current interaction and the current entity associated with the initial equity resource offering.

As illustrated in block 420, the process 400 continues by performing training of a machine learning module using the data segments outlined above in FIG. 2. In this way, the system may train a machine learning module to identify potential resource agents based on the data segments. The machine learning system implemented is a network structure that contains nodes or layers that are stacked to perform a specific task and review of a specific subsection of the four data segments. Each type of layer represents a specific low-level transformation (e.g., convolution, pooling) of the input data segments with specific parameters (i.e., weights). The architecture is an abstraction of a set of networks or applications that have the same types and order of layers but do not specify the number and dimension of layers. In this way, generating a trained predictor of resource agents to target for the entity investment prior to the initial equity resource offering.

Next, as illustrated in block 430, the process 400 continues by using the machine learning model to determine one or more potential resource agents for the interactions. As such, the data segments specific for the entity may be processed to determine resource agents of possible interest for entity investment. This may be based on a match between data segments of the resource agents and data segments about the entity. As illustrated in block 440, the process 400 continues by calculating the match between the potential resource agents for the interaction and the entity associated with the interaction. The match includes a percentage of probability that the agent may inject into the interaction.

As illustrated in block 450, the process 400 continues by calculating and including a potential order size associated with the resource agent injection in to the interaction. In this way, the system may be able to also predict an amount of involvement with the entity that the resource agent may be interested in. This involvement may be in the form of a distribution of resources from the resource agent. Furthermore, the system may identify the subscription level of the interaction based on the processing. In addition, once one or more resource agents are identified, the system may utilize historical user interaction data with those particular resource agents to develop a pitch strategy for approaching the resource agent in this particular interaction.

As illustrated in block 460, once the machine learning processing and analysis has been performed on the data segments, the system may generate and present a display of the results report on a secure user device. In this way, the graphical user interface may display results to an authorized user that has been authorized into the interface. These results include predicted resource agents, order size potential, a subscription level, and pitch strategies for approaching the predicted resource agents.

Finally, after the launch of the initial equity resource offering, the system may review the launch and review the interaction to create a feedback results loop. In this way, as illustrated in block 470, the process 400 is completed by feeding the generated results and finalized outcome of the interaction back into the pool of data segments to enhance the accuracy of the model via backpropagation.

After an interaction has completed, the system may be able to also review data segments to potentially identify new entities that may be next in line for system processing for an initial equity resource offering. As such, finding new customers for users to process via the system.

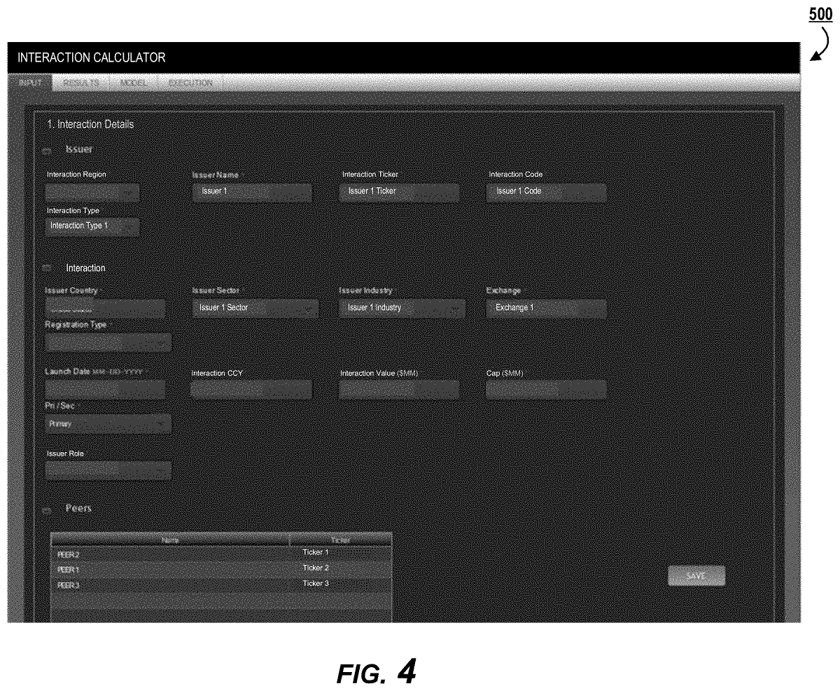

FIG. 4 provides an interface illustrating an input tab of the interaction calculator application associated with the machine intelligence resource agent indicator output system 500, in accordance with one embodiment of the present invention. As illustrated, the interaction calculator has multiple tabs for input, results, model, and execution. The input tab allows a user to input information about the entity or issuer that is preparing for the initial equity resource offering, follow-ons, blocks, and the like. A user may authenticate and log into the interface. Upon a new interaction being initiated, the user may input information about the entity such as a region, the entity name, symbol, interaction code, and interaction type. Furthermore, the user may input information about the interaction, such as a region, industry, exchange, date, and the like. Finally, the system or the user may select and input various peers to the entity. These peers may be similar in sector, size, location, or the like. Once inputted, the user may save the information about the entity and the data may be applied to one or more data segments for analysis. Upon saving, the user is directed to the execution tab.

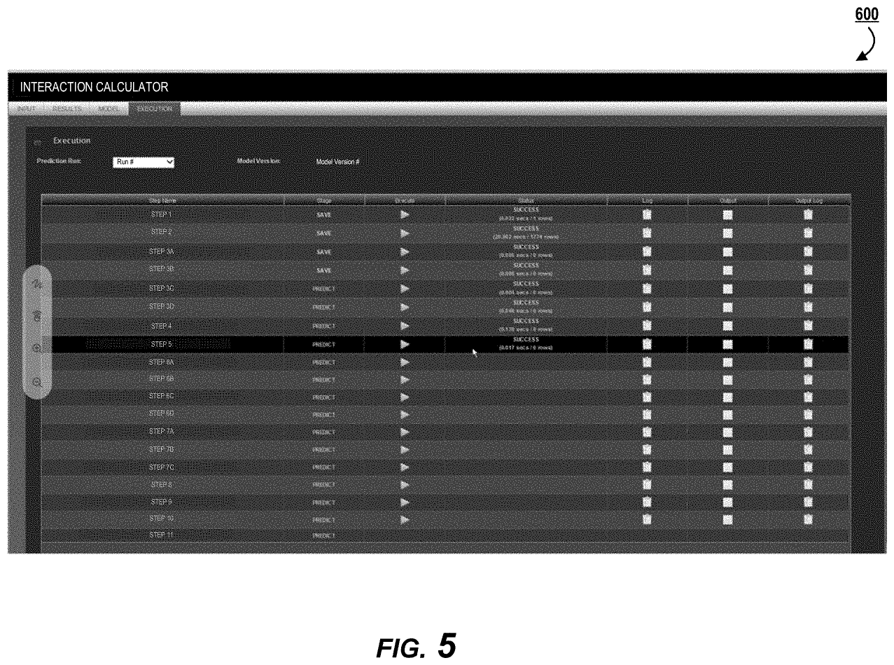

FIG. 5 provides an interface illustrating an execution tab of the interaction calculator application associated with the machine intelligence resource agent indicator output system 600, in accordance with one embodiment of the present invention. The execution tab illustrates the steps being performed by the system. In this way, the steps illustrate the data being pulled from the data segments and the machine learning processing of that data. In this way, the system displays a real-time indication of the execution of the system for tracking the processing of selection of one or more resource agents.

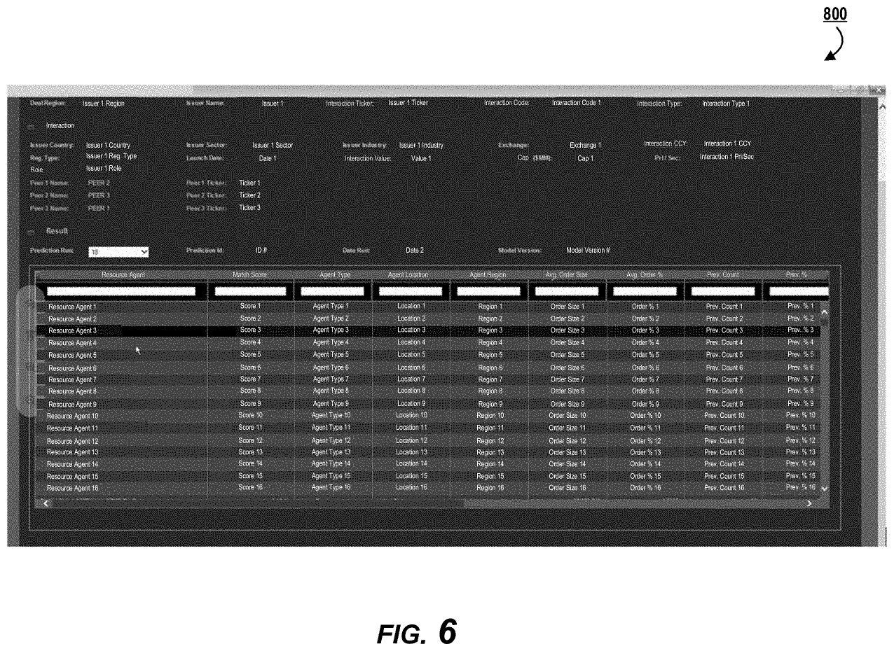

FIG. 6 provides an interface illustrating a model tab of the interaction calculator application associated with the machine intelligence resource agent indicator output system 800, in accordance with one embodiment of the present invention. The model step illustrates the model size, predicted time for processing, sample size for the modeling for the processing.

Furthermore, this interface application illustrates more information about the resource agent. The top portion of the interface illustrate information about the entity that was inputted in the input interface, while the bottom portion of the interface provides information about the resource agents that are most likely to be involved and/or invest in the entity. The interface illustrates the score, the type of agent, the agent location, the agent region, an agent average order size, order percentage, previous contact with the agent, and the like. This provides the user with a detailed list of the resource agents based on the machine learning processing and predicting for the entity interaction.

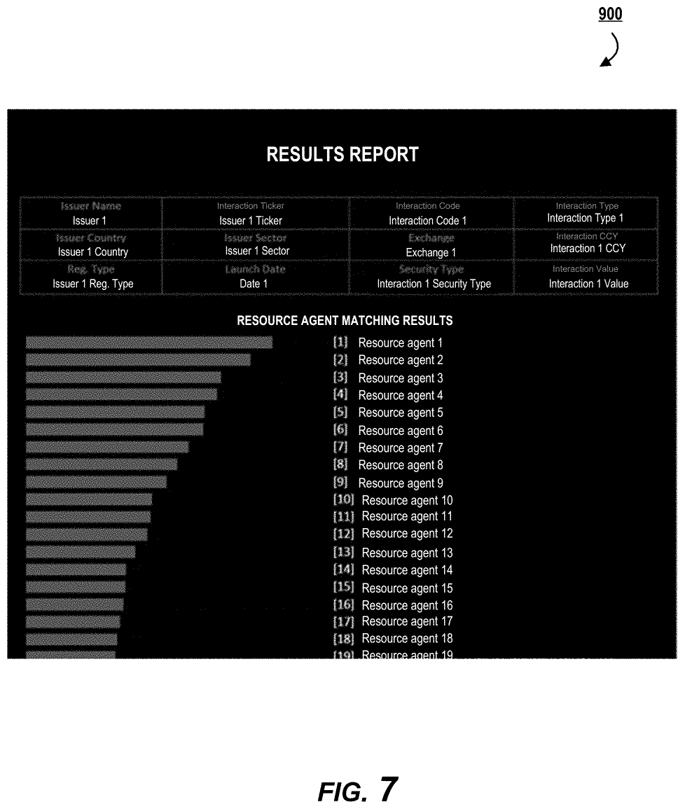

FIG. 7 provides an interface illustrating a results tab of the interaction calculator application associated with the machine intelligence resource agent indicator output system 900, in accordance with one embodiment of the present invention. As illustrated Issuer 1 is illustrated as the entity customer for the initial equity resource offering. This shows the information about the entity, such as the ticker, country of the entity, interaction codes associated with the interaction, date of the interaction, sector of the entity, and the like. Below the system illustrates resource agent matching results based on the machine learning processing of the data segments. These include one or more resource agents and the level of predicted interest the system identifies that may be more interested in the entity based on the data segment processing.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function. As such, once the software and/or hardware of the claimed invention is implemented the computer device and application-specific circuits associated therewith are deemed specialized computer devices capable of improving technology associated with the in authorization and instant integration of a new credit card to digital wallets.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a special purpose computer for the authorization and instant integration of credit cards to a digital wallet, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for machine intelligent resource agent indicator output, the system comprising:
a memory device with computer-readable program code stored thereon;
a communication device, wherein the communication device is configured to establish operative communication with a plurality of networked devices via a communication network;
a processing device operatively coupled to the memory device and the communication device, wherein the processing device is configured to execute the computer-readable program code to:
identify an interaction, wherein the interaction is an equity resource exchange or an initial equity resource offering requiring resource agents;
compile data from data segments associated with the interaction, wherein the data segments include historical interaction data segments, issuer data segments, research data segments, and sales data segments;
identify target resource agents for injection into the interaction based on process the compiled data from the data segments via machine learning modeling;
calculate a probability match and a probability order size for each of the target resource agents identified for injection into the interaction; and
generate and display for a results report on a secure user access via an application hub, wherein the results report includes a graphical user interface with target resource agents and calculated probability matches.

2. The system of claim 1, further comprises feeding results of equity resource exchange or an initial equity resource offering and target resource agent involvement back into the machine learning modeling for enhanced accuracy via backpropagation.

3. The system of claim 1, wherein the results report further comprises a pitch strategy for approaching the target resource agents for equity resource exchange or an initial equity resource offering funding based on agent historical interaction data.

4. The system of claim 1, wherein the data from data segments is compiled into a single display for a user and is walled from data sources and outputs prohibiting cross contact of data across an sector.

5. The system of claim 1, wherein the data from data segments comprise historical interaction data, wherein historical interaction data includes data from previous resource agent interactions, previous involvement in entity initial equity resource offerings, wherein the historical interaction data is further parsed into an interaction type, an issuer location, and an interaction sector.

6. The system of claim 1, wherein the data from data segments comprise issuer data, wherein issuer data further comprises entity trends, entity volatility, and an identification of what resource agents are currently invested with the entity prior to the initial equity resource offering.

7. The system of claim 1, wherein the data from data segments comprise research data, wherein the research data further comprises research of an entity or sector within a line of business.

8. The system of claim 1, wherein the data from data segments comprise sales data, wherein the sales data further comprises identifying when the user contacts a resource agent and identifying the resource agent contacts overtime with respect to sectors or entities include interaction volumes, a touchpoint count, and sector sales.

9. A computer program product for machine intelligent resource agent indicator output, the computer program product comprising at least one non-transitory computer-readable medium having computer-readable program code portions embodied therein, the computer-readable program code portions comprising:
an executable portion configured for identifying an interaction, wherein the interaction is an equity resource exchange or an initial equity resource offering requiring resource agents;
an executable portion configured for compiling data from data segments associated with the interaction, wherein the data segments include historical interaction data segments, issuer data segments, research data segments, and sales data segments;
an executable portion configured for identifying target resource agents for injection into the interaction based on process the compiled data from the data segments via machine learning modeling;
an executable portion configured for calculating a probability match and a probability order size for each of the target resource agents identified for injection into the interaction; and
an executable portion configured for generating and displaying for a results report on a secure user access via an application hub, wherein the results report includes a graphical user interface with target resource agents and calculated probability matches.

10. The computer program product of claim 9, further comprises an executable portion configured for feeding results of equity resource exchange or an initial equity resource offering and target resource agent involvement back into the machine learning modeling for enhanced accuracy via backpropagation.

11. The computer program product of claim 9, wherein the results report further comprises a pitch strategy for approaching the target resource agents for equity resource exchange or an initial equity resource offering funding based on agent historical interaction data.

12. The computer program product of claim 9, wherein the data from data segments is compiled into a single display for a user and is walled from data sources and outputs prohibiting cross contact of data across an sector.

13. The computer program product of claim 9, wherein the data from data segments comprise historical interaction data, wherein historical interaction data includes data from previous resource agent interactions, previous involvement in entity initial equity resource offerings, wherein the historical interaction data is further parsed into an interaction type, an issuer location, and an interaction sector.

14. The computer program product of claim 9, wherein the data from data segments comprise issuer data, wherein issuer data further comprises entity trends, entity volatility, and an identification of what resource agents are currently invested with the entity prior to the initial equity resource offering.

15. The computer program product of claim 9, wherein the data from data segments comprise sales data, wherein the sales data further comprises identifying when the user contacts a resource agent and identifying the resource agent contacts overtime with respect to sectors or entities include interaction volumes, a touchpoint count, and sector sales.

16. A computer-implemented method for machine intelligent resource agent indicator output, the method comprising:
providing a computing system comprising a computer processing device and a non-transitory computer readable medium, where the computer readable medium comprises configured computer program instruction code, such that when said instruction code is operated by said computer processing device, said computer processing device performs the following operations:
identifying an interaction, wherein the interaction is an equity resource exchange or an initial equity resource offering requiring resource agents;
compiling data from data segments associated with the interaction, wherein the data segments include historical interaction data segments, issuer data segments, research data segments, and sales data segments;
identifying target resource agents for injection into the interaction based on process the compiled data from the data segments via machine learning modeling;
calculating a probability match and a probability order size for each of the target resource agents identified for injection into the interaction; and
generating and displaying for a results report on a secure user access via an application hub, wherein the results report includes a graphical user interface with target resource agents and calculated probability matches.

17. The computer-implemented method of claim 16, further comprises feeding results of equity resource exchange or an initial equity resource offering and target resource agent involvement back into the machine learning modeling for enhanced accuracy via backpropagation.

18. The computer-implemented method of claim 16, wherein the results report further comprises a pitch strategy for approaching the target resource agents for equity resource exchange or an initial equity resource offering funding based on agent historical interaction data.

19. The computer-implemented method of claim 16, wherein the data from data segments is compiled into a single display for a user and is walled from data sources and outputs prohibiting cross contact of data across an sector.

20. The computer-implemented method of claim 16, wherein the data from data segments comprise historical interaction data, wherein historical interaction data includes data from previous resource agent interactions, previous involvement in entity initial equity resource offerings, wherein the historical interaction data is further parsed into an interaction type, an issuer location, and an interaction sector.
